(19) United States
(12) Patent Application Publication
(10) Pub. No.: US 2003/0031207 A1
(43) Pub. Date: Feb. 13, 2003

(54) Method for generating blocks of data, method for processing the same, television broadcasting system employing such methods, and teletext receiver arrangement for use in the system

(76) Inventor: Bhargavi Upadhya, Bangalore (IN)

Correspondence Address: Michael E. Marion, c/o U.S. PHILIPS CORPORATION, Intellectual Property Department, 580 White Plains Road, Tarrytown, NY, 10591, US

(21) Appl. No.: 10/175,414

(22) Filed: Jun. 19, 2002

(30) Foreign Application Priority Data
Jun. 19, 2001 (EP) 01202371.9

(51) Int. Cl. H04J 3/24

(52) U.S. Cl. 370/474

(57) ABSTRACT

A method for generating blocks of data, e.g. teletext pages or electronic program guide structures, comprising data intended for display and control data, which blocks of data can be multiplexed with a composite video signal, e.g. a television signal, wherein the blocks of data are encoded in packets, comprising at least one packet (24) containing at least one data field (29,50,51,57) in which a reference link to (a part of) another block of data (62) is programmed. The reference link is programmed to link an element (49) of the data intended for display in the referring block of data (48) to (a part of) the other block of data (62). A method for processing such data uses the programmed reference link. A teletext receiver arrangement uses this processing method. A broadcasting station (1) and a device (3) for programming blocks of data (24) are adapted to using a method of the first-mentioned kind to generate a signal.

Method for generating blocks of data, method for processing of the same, television broadcasting system employing such methods, and teletext receiver arrangement for use in the system.

The invention relates to a method for generating blocks of data, e.g. teletext pages or electronic program guide structures, comprising data intended for display and control data, which blocks of data can be multiplexed with a composite video signal, e.g. a television signal, wherein the blocks of data are encoded in packets, comprising at least one packet containing at least one data field in which a reference link to (a part of) another block of data is programmed.

WO 97/12484 discloses a method of the type mentioned above, wherein teletext data having a plurality of references to teletext pages is transmitted. References are contained in so-called extension packets. At least one of the references is transmitted as a page number and further references are transmitted in the form of an offset with respect to said page number. A reference can also refer to parts of a teletext page. This allows references to sections of pages containing information on television schedules. Teletext receiver arrangements equipped with an electronic program guide function can use such references.

Using the known method, one can only link the entire referring page to the element being referred to. The way in which the link is displayed depends on the teletext receiver arrangement. Usually the teletext receiver arrangement will decrease the area of the screen showing the teletext page, to make room for a separate section showing the links.

It is an object of the present invention to provide a method of the type mentioned above, with which more refined links can be programmed.

Accordingly, the method according to the invention is characterised in that the reference link is programmed to link an element of the data intended for display in the referring block of data to (a part of) the other block of data.

This allows the broadcaster to add more specific references, for example in the case where a block of data intended for display contains several unrelated topics. A viewer can more easily be directed to other information concerning the topic of his interest.

The existing method has the disadvantage that the broadcaster has no control over what is done with the links after reception. For example, a teletext receiver arrangement may display all links on the screen in the same colour. If the broadcaster considers some links more important than others, there is no simple way in which he can make this apparent to the viewer.

In a preferred embodiment of the method according to the invention, the reference link is programmed to provide for emphasised display, as a hotspot, of the element of data intended for display.

This further draws the attention of the user to the fact that a link is available from the particular element.

The method according to the invention is intended to be compatible with existing standards. These standards commonly provide for the use of a special kind of data field for programming links to other blocks of data. Only a limited number of such data fields are available within the total set of data fields comprised in one referring block of data. For example, the teletext standard allows four links per page. The standard for electronic program guides allows for only one link for each event in a navigation information structure.

Methods are known which use additional data fields not yet assigned in the standard in order to provide additional links. However, the receiver arrangement then has no easy way of determining how many reference links are provided from one block of data. Therefore, these methods often require procedures by which the teletext receiver arrangement evaluates all unassigned data fields to determine their contents.

The present invention can be used to extend the number of links that are provided with a block of data. In a preferred embodiment of the method according to the invention, one or more data fields are programmed to indicate the availability of, and identify a data field in which a reference link has been programmed.

This allows for efficient processing of the received data when setting up the links. The receiver arrangement can stop analysing the data stream after all available data fields in which a reference link has been programmed have been dealt with.

The invention will now be further described with reference to the attached drawings, of which

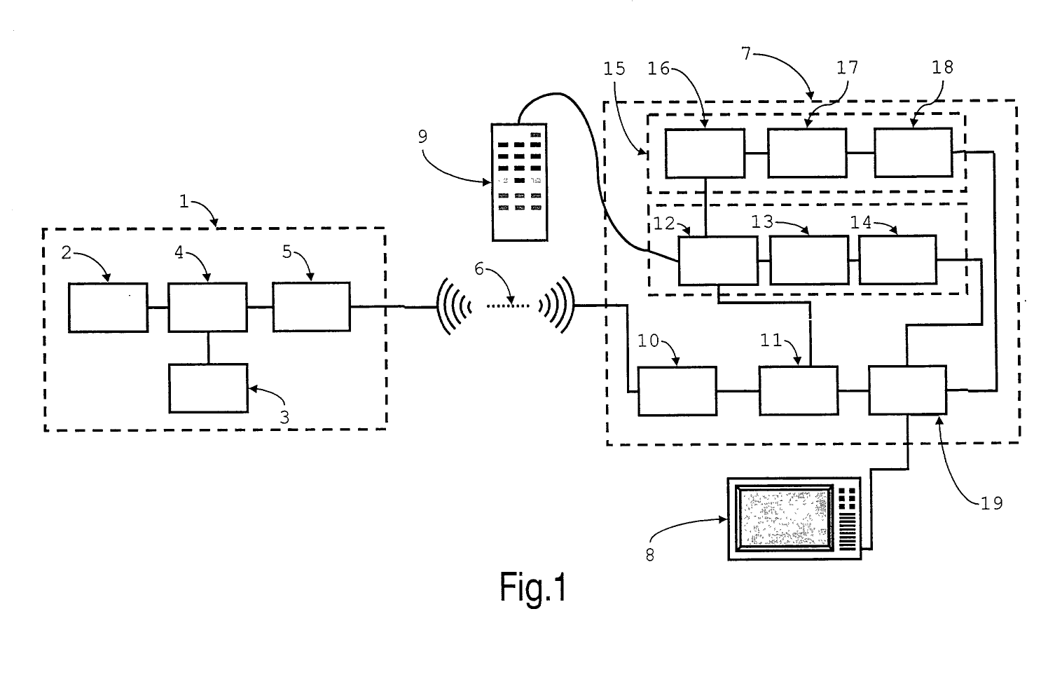

FIG. 1 shows a schematic drawing of a television broadcasting system, adapted for carrying out an embodiment of the method according to the invention,

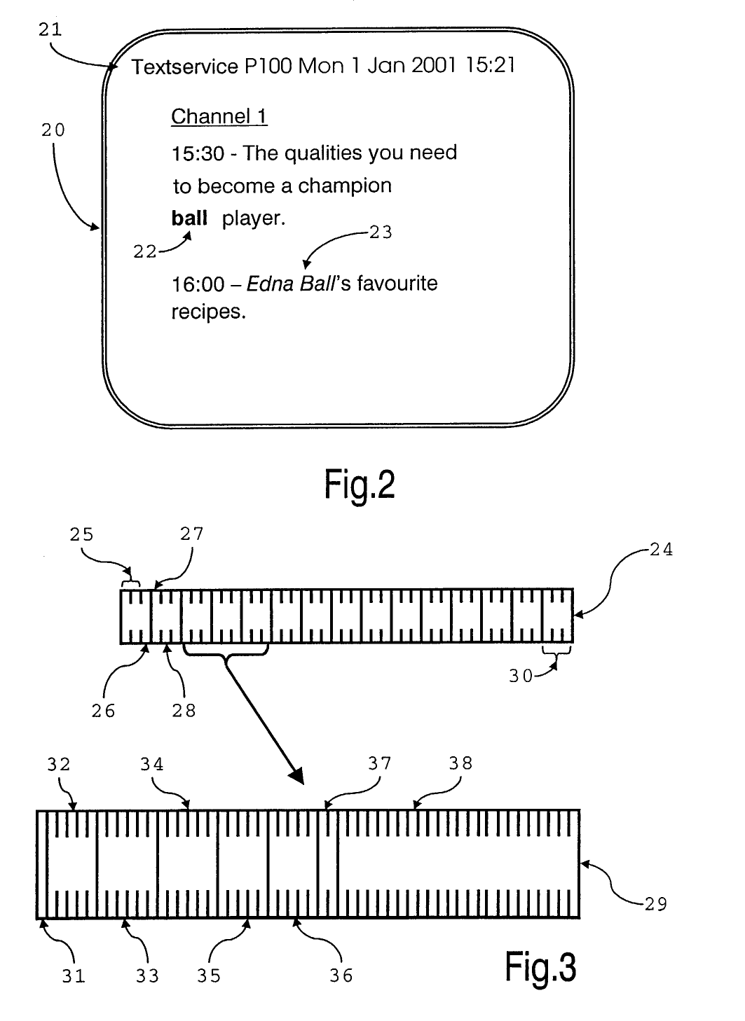

FIG. 2 shows a screen image of a teletext page, as an example of a block of data generated using an embodiment of the invention,

FIG. 3 shows the composition of a packet containing a data field in which a reference link between a displayable element of the teletext page of FIG. 2 and a section of another teletext page has been programmed according to an embodiment of the method of the invention,

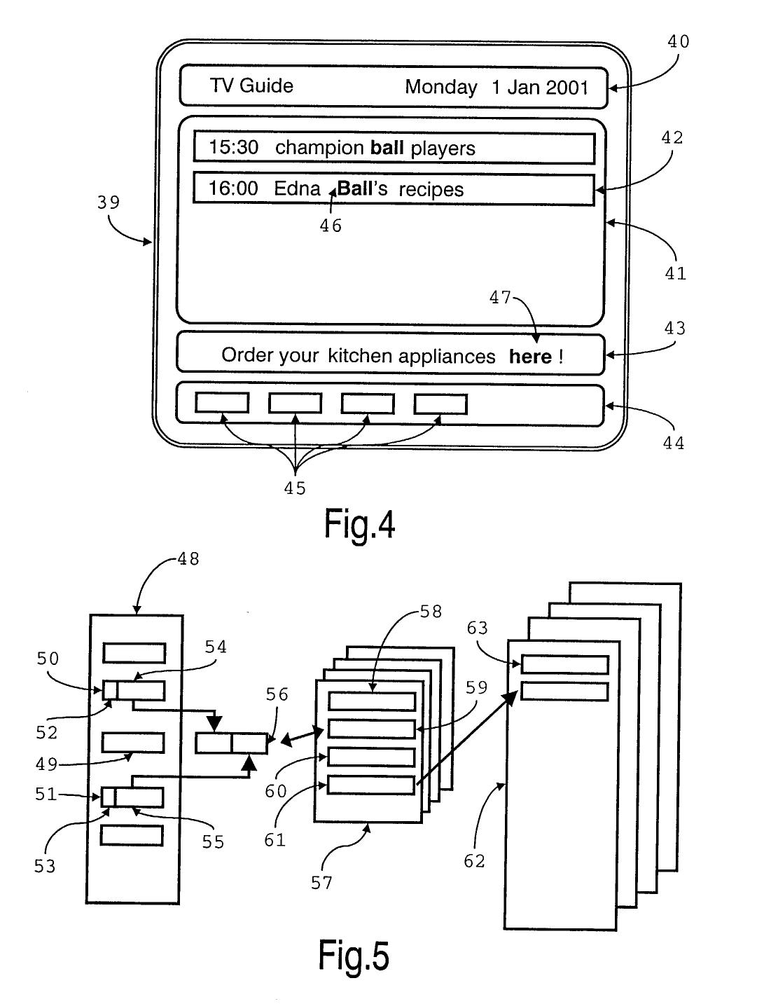

FIG. 4 shows a screen image from an EPG, obtained from blocks of data encoded in accordance with an embodiment of the invention,

FIG. 5 schematically shows the linking mechanism according to an embodiment of invention, as applied to an EPG.

FIG. 1 shows a schematic drawing of the main elements of a television broadcasting system. The system shown is capable of broadcasting teletext pages and electronic program guide (EPG) information with the television signal.

The system comprises a broadcasting station 1, where a broadcasting signal is composed and from where it is transmitted to the viewer. Of course, composition and transmission need not be done by the same organisation or at the same location.

A composite video signal is generated in a TV studio 2. It is not essential to the invention that the composite video signal be generated in a TV studio or that it consist of television images. It could also be a cartoon generated on a graphical workstation, for instance. Additionally, the fact that the signal is referred to as a composite video signal does not exclude the possibility that the signal from the TV studio 2 comprises sound.

Multiplexed with the composite video signal from the TV studio 2 are blocks of data. In the example of FIG. 1 these blocks of data are teletext pages, or content for an EPG, which is generally encoded and transmitted in a format compatible with that of teletext pages. The blocks of data are generated using an editing terminal 3. The editing terminal 3 will usually be a computer running a special program for generating teletext pages and/or EPG blocks of data.

Teletext pages are encoded in packets. Each data packet comprises a part of a teletext page or a block of data for a teletext based service, e.g. subtitling, EPG, Conditional Access, etc. In the shown embodiment of the invention, the blocks of data created with the editing terminal 3 are inserted into the composite video signal in a multiplexing unit 4. The signal from the multiplexing unit 4 is then broadcast using a TV transmitter 5. Of course, a registration of the signal on a storage medium could be made first to allow transmission at a later time.

Within the scope of the invention, the data packets can be multiplexed with the composite video signal in a number of ways, depending on the particular television format.

The preferred embodiment makes use of the virtual blanking interval, which exists in interlaced analogue TV formats. Examples of interlaced formats exist in 25 Hz and 30 Hz variants, amongst others the NTSC, PAL and SECAM formats. The number of horizontal lines per frame can vary per format. Common values are 525 or 625 horizontal lines per frame. The method according to the invention can be implemented in any of these formats, whereby a packet is inserted into the composite video signal as if it were a line in a frame in the video signal.

If the TV format uses progressive, or sequential, scanning, the method according to the invention can still be used. A packet can still be inserted into the composite video signal, as if it were a horizontal line in a video frame, for example between frames.

The method according to the invention is not limited to analogue TV formats. Digital television formats also allow for the transmission of blocks of data in packets. In this case, the composite video signal is also a stream of data, programmed in packets. The packets for teletext contain an identifier, allowing them to be distinguished from the other packets.

The transmitter 5 broadcasts the composite video signal with the multiplexed blocks of data to the user, across a broadcasting link 6. The broadcasting link 6 can be based on one of several possible techniques. The method according to the invention is not limited to a particular broadcasting technique. For instance, terrestrial wireless transmission may be used, digital satellite broadcasting, cable networks, etc. The signal may be scrambled or compressed, for instance according to the MPEG-2 format, before transmission. It is then reconstructed after reception.

The viewer has at his disposal a television set comprising a teletext receiver arrangement 7. The teletext receiver arrangement 7 receives the broadcast signal from the broadcasting station 1. Connected to the teletext receiver arrangement 7 are a television 8, on which the images are made available, and a control unit 9 for selecting teletext pages, navigating through an EPG, and selecting television channels. The control unit 9 can be a remote control or some device integrated into the teletext receiver arrangement 7.

The television 8 and teletext receiver arrangement 7 are shown separately in FIG. 1, to provide a better understanding of its components. An actual television set will be one unit, with the teletext receiver arrangement built in. The teletext receiver arrangement can, however, also be built into a video recorder or be a separate unit.

The teletext receiver arrangement 7 of FIG. 1 comprises a tuner 10 for tuning to the frequency at which the broadcasting station 1 has broadcast the signal and demodulating the signal. The tuner 10 can also take care of decompression or de-scrambling of the signal, if necessary. A switching unit 11 separates the data packets from the composite video signal. The data packets are transferred to a teletext processing unit 12. This unit 12 processes the packets, decodes the information, to generate pages for electronic program guides or teletext, and makes pages available upon a request entered by means of the control unit 9. Because blocks of data are not sent in a continuous stream, copies can be kept in a page memory 13, comprised in the teletext receiver arrangement 7. Pages kept in the page memory 13 are updated when a new version has arrived and has been processed by the teletext processing unit 12. Upon a request for a particular teletext page, a screen image is composed in a display section 14, in a format suitable for display on the television 8.

The teletext receiver arrangement 7 of FIG. 1 additionally comprises an EPG engine 15. If the teletext processing unit 12 determines that a particular block of data is part of an EPG, it is transferred to the EPG engine 15. The EPG engine 15 comprises an EPG decoder 16, an EPG database 17, and a presentation engine 18. The EPG decoder 16 collects and decodes transmitted EPG data. The EPG database 17 is used for storing EPG data, and is updated when a more recent version is made available. The presentation engine 18 draws screen images from the available EPG data, which can be shown on the television 8.

A multiplexer 19 makes the data intended for display available to the television 8, or the composite video signal, or a combination of the two (in the case of subtitling or split-screen displays, for instance).

The teletext receiver arrangement 7 can comprise additional modules for other services, including, but not limited to, such services as conditional access, network identification and navigation via a Table Of Pages.

The blocks of data with which the present invention is concerned are those comprising data intended for display. FIG. 2 shows a screen image 20 of a teletext page, an example of such a block of data. It comprises a page header 21 in a standard format. The header format is the same for each page provided by a teletext service. The screen image 20 further contains hotspots 22,23. Hotspots are representations of elements of data intended for display, such as a teletext page. They can be in the shape of text, i.e. a string of characters, or images. Because a hotspot is displayed with emphasis, it provides an indication to the viewer that a reference link is available from this particular element of a teletext page. The image 20 of FIG. 2 comprises a first hotspot 22 from which a reference link has been programmed, and a second hotspot 23 from which a different link has been programmed.

In a preferred embodiment of the method according to the invention different kinds of emphasised display of a displayable element from which a link has been programmed are possible. For example, the first hotspot 22 is in bold lettering, whereas the second hotspot 23 is in italics. Other types of display, e.g. blinking or highlighted, are possible. This makes it easier to alert the viewer to the presence of a link from the particular element and to distinguish between the links. In all cases, the manner of display is determined from data comprised in the data field in which a reference link has been programmed.

By way of non-restrictive example, FIG. 3 shows the composition of a packet 24 in which a block of data, in this case a part of a teletext page, has been encoded. The example of FIG. 3 conforms to the European Telecommunication Standard ETS 300 706, herein incorporated by reference.

The packet 24 comprises forty-five bytes, each consisting of eight bits. The packet 24 is divided into groups of three bytes, referred to as triplets. Thus, the packet 24 consists of fifteen triplets. Twenty-six packets encode one teletext page. The first packet is used to encode the page header 21, whereas the other twenty-five packets encode the rest of the page.

The first three bytes define a synchronisation sequence 25, consisting of a clock run-in sequence of alternating one's and zeroes and a framing code. The framing code identifies the packet 24 as a teletext packet.

The next byte defines a magazine number 26. The magazine number 26 is used to distinguish a group of related packets.

A next byte defines a packet number 27. Since the packet number 27 of the example is one byte long, it can have values in the range of zero to thirty-one. The packet number 27 identifies the type of the packet 24. The packet number 27 of a packet encoding a page header is zero. Packets encoding data intended for direct display in a teletext page have values from one to twenty-five. Page-related packets containing control data, which is not directly displayable have numbers from twenty-six to twenty-eight. These packets are commonly referred to as extension packets. Packet numbers twenty-nine to thirty-one can contain data related to all the pages in a magazine with the same value for the magazine number 26.

Extension packets can be further distinguished through an optional designation code 28, comprised in the sixth byte of the packet. Thus, an extension packet can be referred to by a number X/Y/D, where X is the value of the magazine number 26, Y the value of the packet number 27, and D the value of the designation code 28.

The preferred embodiment of the invention makes use of data fields in extension packets to program a link from a displayable element, encoded in a packet for direct display, to a block of data, for example another teletext page or a part of another teletext page. The data field in which a reference link is programmed is thus programmed in data fields in the control data of the referring block of data.

In principle, any of the extension packets, or a packet with a packet number 27 value between twenty-nine and thirty-one can be used, but in the preferred embodiment of the invention links are programmed in packets which are not used for other teletext-based services. For example, the packets X/27/8-15 could be used.

Since the first two triplets in the packet 27 are used to encode the synchronisation sequence 25, the magazine number 26, the packet number 27, and the designation code 28, thirteen triplets are left, in which to program reference links.

In FIG. 3, an enlarged view is provided of a reference link data field 29, consisting of three triplets. One reference link has been programmed in the data field 29. As the reference link data field 29 comprises three triplets, four reference links can be programmed in one packet 24. The reference link data field 29 has a special data structure, dedicated to providing the data concerning the reference link.

An important aspect of the shown embodiment of the invention is that more links can be provided than are possible within the existing standards. Reference links can be programmed in all or several of the packets X/27/8-15.

In order that the teletext processing unit 12 need not search all of the possible packets for the presence of reference link data fields 29, a triplet 30 indicating availability of, and identifying, a further reference link is provided. In the example of FIG. 2, this is the last triplet in the packet 24, which is not used for programming reference links. If a further link is available, the first bit of the triplet 30 will be zero and the other bits will provide the value of the designation code of the packet containing the next reference link data field 29. If no further reference link data fields 29 are present in the other packets, then the triplet 30 can be a terminator triplet with the most significant bit set to zero.

The method used by the teletext processing unit 12 to process the data, allows it to determine the availability of a reference link from the data comprised in the last triplet. If no links are available, the teletext processing unit 12 determines that it need not look for further reference link data fields 29 in the packets transmitted next.

The reference link data field 29 of FIG. 3 comprises eight sub-fields 31-38. The first sub-field is a terminator sub-field 31, consisting of one bit which is normally set to zero, but is needed to distinguish the reference link data field 29 from a terminator triplet. The combination of packet number 27, designation code 28, and terminator sub-field, forms a special code, identifying the reference link data field 29 as such.

The next three sub-fields 32-34 identify the element of the data intended for display from which to provide a link, by its position in the screen image 20. A row number sub-field 32 indicates in which row in the page the element will be located when displayed. A start column sub-field 33 labels the column number of the first symbol of the element, and a stop column sub-field 34 labels the column number of the last symbol of the element.

Alternative ways of indicating the screen position of the displayable element from which to provide a link are conceivable. For instance, pixel numbers could be used instead of row and column numbers. This way would be suitable for programming references to teletext data blocks according to certain standards for digital television. The bit size of the sub-fields 32-34 would then be adapted accordingly, as will be clear to those skilled in the art.

The next three sub-fields 35-37 of the reference link data field 29 provide control over the way in which the display of the element is emphasised. In the example, a foreground colour sub-field 35, a background colour sub-field 36, and a conceal and flash sub-field 37 are provided. Other alternatives for emphasised display are possible within the scope of the invention.

Ideally, the special program running on the editing terminal 3 provides a “What you see is what you get” editing environment, so that the blocks of data can be seen as the television viewer would see them. In this way, the link from an element of the data intended for display in the referring block of data can be programmed to best effect.

The last sub-field in the reference link data field 29 is a linked data address field 38. This gives the address of the block of data to which reference is made. In the example, it consists of the magazine number 26 and a subcode number, for referring to a section of another teletext page.

FIG. 4 shows a screen image 39 from an EPG, comprised of blocks of data encoded in accordance with an embodiment of the invention. This embodiment of the invention is compatible with standard ETS 300 707, herein incorporated by reference.

The screen image 39 comprises a header area 40. The operator of the editing terminal 3 determines what information is displayed in the header area 40. Usually, the header area 40 will be used to provide the viewer with information on his current location in the electronic program guide.

The screen image 39 further comprises an event area 41, displaying events 42. The event area 41 can display a variable number of events 42. The displayed events 42 will usually be items in a list. For example, an event 42 can contain the program information of one program, or an item in a menu. If the event 42 contains program information, it can be used to build a program listing in the event area 41, consisting of several of such events 42.

The screen image 39 also comprises a message area 43, used to display messages. A message can be related to the currently selected event 42 in the event area 41, for example containing advertising.

The screen image 39 also comprises a navigation area 44, containing navigation buttons 45. The navigation buttons 45 present commands for moving around within the EPG. A user selects a navigation button 45 when he wants to execute the command concerned.

The method according to the invention allows the operator of the editing terminal 3 to program reference links, linking an element of data intended for display in an EPG, e.g. a word in an event 42, to another block of data. The displayable element can be intended for display in any of the areas 40,41,43,44 of the screen image 39. For instance, it can be a string, forming a word intended for the message area, linking advertising to more detailed product information. The block of data to which the link is directed can be an EPG block or a part of a teletext page.

The element from which the link is provided can again be displayed as a hotspot, i.e. in a format for emphasised display. The screen image 39 contains two examples 46,47 of such hotspots. A hotspot 46 is provided in the event area and another hotspot 47 is provided in the message area.

The data used in an EPG is clustered in blocks of data. These exist in various types. One example is the Application Information (AI) data structure, describing the EPG characteristics. Another example is the Programming Information (PI) structure, which conveys the parameters of programmes. Typical parameters are start and stop time, network, but also text strings describing the program and providing other program related information. A third example is the Navigation Information (NI) structure, which contains a list of events used for navigation through the EPG. These can be used to build menu trees on-screen. The NI data structure can also contain elements of data intended for display, like strings containing descriptions of an event. A Message Information (MI) structure contains displayable elements intended for the message area 43. Another data structure, which can contain elements of data intended for display, is the On-Screen Display Information (OI) structure. Apart from the data intended for display, it also contains control data, comprising information on the build-up of the screen image 39. Several instances of a data structure occur in one EPG. Each instance is called a block.

In the method according to the invention, the details of the (part of) a block to which a link is provided are programmed in data fields in a block which is distinct from the referring block of data.

Such a block has a dedicated data structure, the Hotspot Information (HI) structure. The availability of an instance of the HI structure is indicated by data comprised in the referring block of data.

TABLE 1

| Hotspot Information | |
|---|---|
| Structure | No. of bits |
| EPG Header | 16 |
| Block Number | 16 |
| Link Type | 8 |
| Link Info | 32 |

Table 1 shows the syntax of a preferred embodiment of the HI data structure. The EPG Header comprises an application identification and a value for the block size. The application identification is a code to distinguish the EPG to which this block belongs from other EPGs, in case several EPGs are available. The block size gives the size of the block. Two blocks that are both instances of the same data structure need not be equal in size. For this reason, a data field containing the block size is provided.

The block number is a code distinguishing the block from other instances of the HI structure. The Link Type indicates the data structure of which the block to which a link is to be provided is an instance. It can be another block of data of the EPG, like a PI, MI, or NI structure, or it can be a (part of a) teletext page.

Depending on the value of the Link Type, the Link Info data field will indicate the location of the block of data to which the reference link is programmed. For example, if the Link Type indicates that the link is to a section in a teletext page, the Link Info will contain a data field indicating the network info, i.e. the television channel, one containing the page number, and optionally a sub-code, referring to a section of the page. If the Link Type indicates that the link is to a PI structure, the Link Info will contain a data field indicating the network info, one containing the block number being referred to, and one containing the identity of (the part of) the block to which reference is made.

By way of example, FIG. 5 schematically shows the linking mechanism according to an embodiment of invention as applied to an EPG. A referring block 48 is schematically represented in FIG. 5. It contains an element 49 of data intended for display, for instance a string of characters forming a word. An initial escape sequence 50 has been inserted before the displayable element 49. A terminal escape sequence 51 has been inserted after the displayable element 49. Thus, the EPG engine 15, using a method according to the invention for processing the received data, can identify the element from the initial and terminal escape sequences 50,51, which indicate the boundaries of the displayable element 49 by their position in the referring block 48 of data. In this way, it is possible to provide for emphasised display of the displayable element 49, since a different mode of display can be chosen for the element 49 between the initial and terminal escape sequences 50,51.

Standards for EPGs provide for escape sequences to be used for other purposes, for instance for indicating carriage returns and language-specific special characters. Therefore, the initial and terminal escape sequences 50,51 are identified as initial and terminal escape sequence by an escape mode indicator 52,53. In a preferred embodiment of the invention, the escape mode indicators 52,53 have values, which have not yet been assigned in the existing standards, to ensure compatibility. For instance, in an embodiment conforming to the ETS 300 707 standard, the escape mode indicators 52,53 of the initial and terminal escape sequences 54,55 could have values 0X20 and 0X21, respectively.

The initial and terminal escape sequences 54,55 further comprise initial and terminal escape sequence data fields 54,55. The data contained in the initial and terminal escape sequence data fields 54,55 is used to construe a Hotspot Information block number 56. So as not to transmit redundant information to the teletext receiver arrangement 7, it is advantageous to provide half the Hotspot Information block number 56 with the initial escape sequence data field 54, and the other half with the terminal escape sequence data field 55. The Hotspot Information block number 56 can then be determined by concatenating the two halves. This number 56 forms a special code, identifying the Hotspot Information block 57 as such.

The Hotspot Information block number 56 identifies a Hotspot Information block 57, which contains the rest of the information concerning the reference link. As is schematically shown in FIG. 5 this includes an EPG Header 58, a Block Number 59, identical to the Hotspot Information Block Number 56, and values for the Link Type 60, and for the Link Information 61.

As mentioned in the discussion of the syntax of the Hotspot Information data structure, the Link Type 60 indicates the data structure of which the block to which a link is to be provided is an instance. The Link Information 61 identifies a block 62, to which the link is provided, and optionally a section within the block 62. Therefore, at least part of the Link Information 61 should correspond to the value of an identifier 63 in the data block 62.

The invention is not restricted to the above-described embodiments, which can be varied in a number of ways within the scope of the claims. In particular, the order in which the various blocks of data have been described does not imply that a particular order of transmission is necessary. Similarly, extra data fields can be added to the described blocks of data within the spirit of the invention.

1. Method for generating blocks of data, e.g. teletext pages or electronic program guide structures, comprising data intended for display and control data, which blocks of data can be multiplexed with a composite video signal, e.g. a television signal, wherein the blocks of data are encoded in packets, comprising at least one packet (24) containing at least one data field (29,50,51,57) in which a reference link to (a part of) another block of data (62) is programmed, characterised in that the reference link is programmed to link an element (49) of the data intended for display in the referring block of data (48) to (a part of) the other block of data (62).

2. Method according to claim 1 wherein the reference link is programmed to provide for emphasised display, as a hotspot, of the element (49) of the data intended for display.

3. Method according to any one of the preceding claims, wherein the data field (29,60,61) in which a reference link is programmed is comprised in a dedicated data structure.

4. Method according to any one of the preceding claims, wherein each data field (24,60,61) in which a reference link is programmed, is identified as such by a special code (27,28,31,59).

5. Method according to any of the preceding claims wherein one or more data fields (30,50,51) are programmed to indicate the availability of, and identify, a data field (29,60,61) in which a reference link has been programmed.

6. Method according to any one of the preceding claims, wherein a data field (29) in which a reference link is programmed contains one or more sub-fields (32-34) identifying the element (49) of the data intended for display.

7. Method according to claim 6, wherein the element (49) is identified by its position in a screen image, when displayed.

8. Method according to any one of the preceding claims, wherein the details of the (part of) the other block of data (62) are programmed in data fields (29) in the control data of the referring block of data.

9. Method according to any one of claims 1-5, wherein the details of the (part of) the other block of data (62) are programmed in data fields (60,61) in a block of data (57) which is distinct from the referring block of data (48).

10. Method for processing blocks of data, e.g. teletext pages or electronic program guide structures, comprising data intended for display and control data, wherein the blocks of data are separated from a composite video signal, e.g. a television signal, with which they have been multiplexed, the blocks of data being encoded in packets, comprising at least one packet (24) containing at least one data field (29,50,51,57) in which a reference link to (a part of) another block of data (62) has been programmed, characterised in that a programmed reference link is used to provide a link from an element (49) of the data intended for display in the referring block of data (48) to (a part of) the other block of data (62).

11. Method according to claim 10, wherein the availability of a reference link from an element (49) of the data intended for display in the referring block of data (48) is determined from data (50,51) comprised in the referring block of data.

12. Method according to claim 11, wherein the data comprised in the referring block of data are initial and terminal escape sequences (50,51), indicating the boundaries of the element (49) and comprised in the data intended for display.

13. Method according to any one of claims 10-12, wherein the element (49) of the data intended for display is displayed with emphasis as a hotspot.

14. Method according to any one of claims 10-13, wherein the manner of display is determined from data comprised in the data field (29,50,51,57).

15. Broadcasting station (1) adapted to using a method according to any one of claims 1-9.

16. Teletext receiver arrangement (7) capable of carrying out a method according to any one of claims 10-14.

17. Television set (7,8), comprising a teletext receiver arrangement (7) according to claim 16.

18. Signal generated using a method according to any one of claims 1-9.

19. Storage medium storing a registration of a signal according to claim 18.

20. Device (3) for programming blocks of data (24) using a method according to any one of claims 1-9.

21. Computer program, which can be loaded onto a computer (3), so that the computer programmed in this way, constitutes a device according to claim 20.

22. Computer readable medium having thereon the code of a computer program according to claim 21.
